(19) United States
(12) Patent Application Publication
(10) Pub. No.: US 2025/0383827 A1
(43) Pub. Date: Dec. 18, 2025

(54) NON-TRANSITORY COMPUTER-READABLE STORAGE MEDIUM STORING SUPPORTING PROGRAM

(71) Applicant: BROTHER KOGYO KABUSHIKI KAISHA, Nagoya (JP)

(72) Inventors: Yoshito HOSOMIZO, Konan (JP); Kenju NARITA, Nagoya (JP); Yushi ICHIKAWA, Nagoya (JP); Airi EGUCHI, Ichinomiya (JP)

(21) Appl. No.: 19/302,832

(22) Filed: Aug. 18, 2025

Related U.S. Application Data
(63) Continuation of application No. PCT/JP2024/003452, filed on Feb. 2, 2024.

(30) Foreign Application Priority Data
Feb. 17, 2023 (JP) 2023-023398

(51) Int. Cl. G06F 3/12

(52) U.S. Cl. CPC G06F 3/1248; G06F 3/1206; G06F 3/1208; G06F 3/1256

(57) ABSTRACT

A non-transitory computer-readable storage medium stores a supporting program executable by a computer of an information processing apparatus and corresponding to a printer connectable to the apparatus. The supporting program causes the computer to perform operations including: in a case where a print instruction instructs a universal printing program included in an operating system incorporated in the apparatus to cause the printer to perform printing an image, obtaining intermediate data representing the image to be printed from the universal printing program; determining whether a first condition corresponding to the printer is satisfied; in response to determining that the first condition is satisfied, causing the universal printing program to compress print data based on the obtained intermediate data using a first compression method supported by the universal printing program, and causing the printer to perform printing based on the print data compressed using the first compression method.

### REFERENCE TO RELATED APPLICATIONS

This a continuation application of International Application No. This PCT/JP2024/003452 filed on Feb. 2, 2024, which claims priority from Japanese Patent Application No. 2023-023398 filed on Feb. 17, 2023. The entire contents of the aforementioned applications are incorporated herein by reference.

### BACKGROUND ART

A technology is known in which printer drivers compress data to be transmitted to printers. For example, a known printer driver that compresses image data enables a computer to generate print data and transmit the print data to a printer.

### SUMMARY

In recent years, a technology has been commercialized in which, instead of using the aforementioned printer driver provided by the printer vendor, a printer is controlled by an OS-standard universal printing program that forms part of an operating system (OS). In this technology, when the OS detects a printer, the OS associates the printer with the OS-standard universal printing program. Thereafter, when the OS receives a print instruction for the printer, the OS-standard universal printing program generates print data without using the printer driver provided by the printer vendor, thereby enabling printing through the OS-standard universal printing program.

However, when an information processing apparatus causes a printer to perform printing via the above-described OS-standard universal printing program, techniques for compressing print data have not been disclosed. In cases where printing is performed via an OS-standard universal printing program, reducing communication load remains desirable; however, techniques for achieving this have not been sufficiently provided, leaving room for improvement.

According to the present disclosure, a non-transitory computer-readable storage medium stores a supporting program executable by a computer of an information processing apparatus and corresponding to a printer connectable to the information processing apparatus. The supporting program causes the computer to perform operations including: in a case where a print instruction output from an application program incorporated in the information processing apparatus instructs a universal printing program included in an operating system incorporated in the information processing apparatus to cause the printer to perform printing an image, obtaining intermediate data representing the image to be printed from the universal printing program; determining whether a first condition corresponding to the printer is satisfied; in response to determining that the first condition is satisfied, causing the universal printing program to compress print data based on the intermediate data obtained in the obtaining using a first compression method supported by the universal printing program, and causing the printer to perform printing based on the print data compressed using the first compression method.

This enables utilization of the compression function of the universal printing program and reduction of communication load via transmission of compressed print data.

The information processing apparatus incorporating the supporting program, a control method for implementing the functions of the supporting program, and a printing system including the supporting program and a printer are also novel and useful.

### BRIEF DESCRIPTION OF THE DRAWINGS

FIG. 1 is a block diagram schematically illustrating an electrical configuration of a personal computer.

FIG. 2 is a sequence diagram illustrating an example of a printing procedure.

FIG. 3 is a sequence diagram illustrating an example of a determination and compression procedure.

FIG. 4 is a flowchart illustrating an example of a determination process.

FIG. 5 is a sequence diagram illustrating an example of a printing procedure.

### DESCRIPTION

Hereinafter, a personal computer (hereinafter, referred to as “PC”) using a supporting program of an embodiment will be described in detail with reference to the accompanying drawings. The disclosure describes the supporting program executable by the PC.

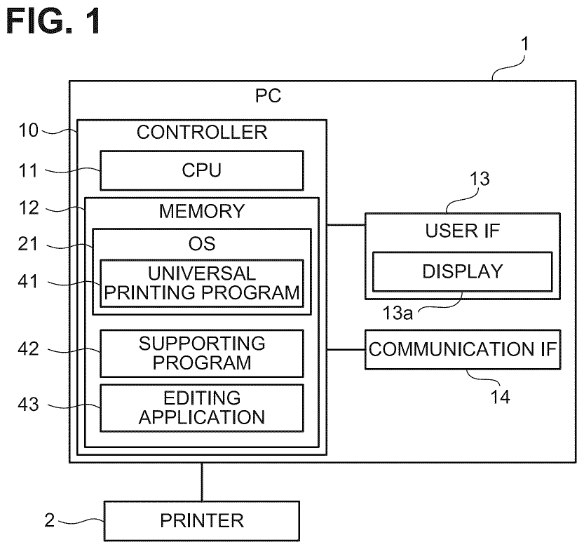

As illustrated in FIG. 1, a PC 1 of the embodiment includes a controller 10 including a CPU 11 and a memory 12. The PC 1 is an example of an information processing apparatus. The CPU 11 is an example of a computer. The PC 1 includes a user interface (hereinafter, referred to as a “user IF”) 13 and a communication interface (hereinafter, referred to as a “communication IF”) 14, which are electrically connected to the controller 10. The term “controller 10” used in FIG. 1 may be a collective term for hardware and software used to control the PC 1, and might not necessarily represent a single piece of hardware actually existing in the PC 1.

The CPU 11 of the PC 1 executes various types of processing in accordance with a program read from the memory 12 or based on user input. The memory 12 stores various programs and various types of data. The memory 12 also serves as a workspace for processing. Examples of the memory 12 include a buffer included in the CPU 11. Examples of the memory 12 further include, but are not limited to a ROM, a RAM, a hard disk drive incorporated in the PC 1, and storage media that are readable and writable by the CPU 11, such as recording media including CD-ROMs and DVD-ROMs.

The user IF 13 includes a display 13a, which is hardware for displaying information to a user. Further, the user IF 13 includes hardware for user input. The user IF 13 may be a combination of the display 13a and an input device having an input reception function, such as a mouse or keyboard, or may be a touch screen having both the function of the display 13a and the input reception function.

The communication IF 14 includes hardware that enables the PC 1 to communicate with an external device such as a printer 2. Examples of a communication standard for the communication IF 14 include Ethernet, Wi-Fi, and USB. Wi-Fi is a registered trademark of Wi-Fi Alliance. The PC 1 may be connectable to the Internet via the communication IF 14. The PC 1 may include multiple communication IFs 14 for supporting multiple communication standards.

As illustrated in FIG. 1, the memory 12 of the PC 1 stores various types of data and programs, including an operating system (hereinafter, referred to as “OS”) 21, a supporting program 42, and an editing application 43. The OS 21 includes a universal printing program 41. The editing application 43 is an example of an application program.

The OS 21 is a multitasking OS that manages multiple tasks and switches between the multiple tasks, thereby handling the multiple tasks simultaneously. The OS 21 may be, for example, Windows, macOS, Linux, iOS, or Android. Windows is a trademark of the Microsoft group of companies. macOS is a registered trademark of Apple Inc. Linux is a registered trademark of Linus Torvalds. iOS is a registered trademark of Cisco Systems, Inc. Android is a registered trademark of Google LLC.

The OS 21 includes the universal printing program 41. The universal printing program 41 is an OS-standard program that is developed by a vendor of the OS 21 and provided as part of the OS 21. That is, the PC 1 is equipped with the OS 21 having the universal printing program 41. The universal printing program 41 is not designed to utilize printer-specific drivers.

The universal printing program 41 enables various types and models of printers provided by different vendors to perform printing based on user instructions. The universal printing program 41 supports general functions that enable various printers to perform printing. Unlike printer drivers specific to each printer, the universal printing program 41 does not support functions that are specific to each printer or printer driver, particularly those that require complicated processing.

The universal printing program 41 includes a function that, in response to a user instruction, receives image data specified as the print target in a print instruction issued from an application and generates intermediate image data based on the image data. The intermediate image data may be, for example, data in XPS format. “XPS” is an abbreviation for XML Paper Specification. The universal printing program 41 further includes a function that generates print data in a format available for printing by various types of printers based on the intermediate image data. The print data is, for example, PWG Raster data or PDF data. The universal printing program 41 further includes a function that transmits the generated print data to a printer designated as a device for printing, using a communication function of the OS 21.

The supporting program 42 consists of a single program or a group of programs that, in association with the processing executed by the universal printing program 41, executes processing based on an instruction received from the OS 21 and supports control of target hardware. The supporting program 42 is provided for the model of the printer 2 connected to the PC 1, for example, by the vendor of the printer 2. The universal printing program 41 launches the supporting program 42 for the printer 2 based on a specific condition. Such a condition may include the designation of the printer 2 as a device for executing printing, the reception of an instruction to specify advanced print settings while the printer 2 is designated, and the reception of an instruction to cause the printer 2 to perform printing. The supporting program 42 may be referred to, for example, as a Print Support Application (abbreviated as PSA) or a Hardware Support Application (abbreviated as HSA).

In one example, the supporting program 42 may be a combination of multiple programs, each of which receives execution commands. In another example, the supporting program 42 may be a single program configured to execute different types of processing based on received commands. Supporting programs may be prepared for different types of printers by a printer vendor. For example, one supporting program may be for inkjet printers and another supporting program may be for laser printers. Supporting programs may be prepared not only for types of printers but also for different models of printer or different series of printer models.

For example, when a printer is newly connected to the PC 1, the OS 21 of the PC 1 may download a supporting program appropriate for the type or model of the connected printer from a server of the vendor of the printer, and incorporate the supporting program into the PC 1. The OS 21 stores identification data of the incorporated supporting program into the memory 12 in association with printer data of the newly connected printer.

The editing application 43 is, for example, a program for creating and editing image data and document data. The editing application 43 may be, for example, Microsoft Word or Microsoft PowerPoint developed by Microsoft or may be a program provided by the vendor of the printer 2. Microsoft, and Microsoft PowerPoint are trademarks of the Microsoft group of companies. The editing application 43 can receive, via the user IF 13, for example, a print execution instruction to cause the printer 2 to perform printing. The editing application 43 is not limited to programs for creating and editing data, and may also include programs that have a function of receiving instructions to display or print various types of information, such as map information or web pages, in response to a user request.

As illustrated in FIG. 1, the PC 1 of the present embodiment is connected to the printer 2 via the communication IF 14. The printer 2 has at least a printing function and a communication function. For example, in response to receiving print data from the PC 1, the printer 2 performs printing based on the received print data. The printer 2 may be an apparatus capable of color printing. The printer 2 may be an apparatus capable of only monochrome printing.

The following describes a procedure, performed on the PC 1 of the present embodiment, for causing the printer 2 to perform printing. Processing executed in each step in the present embodiment essentially indicates processing executed by the CPU 11 in accordance with instructions written in a specific program, such as the supporting program 42. Processing executed by the CPU 11 also includes control of hardware using APIs of the OS 21. In the disclosure, a description will be provided on operations of the programs. A detailed description of the OS 21 will be omitted. The terms related to “obtain” are used to refer to a concept that does not necessarily require a request.

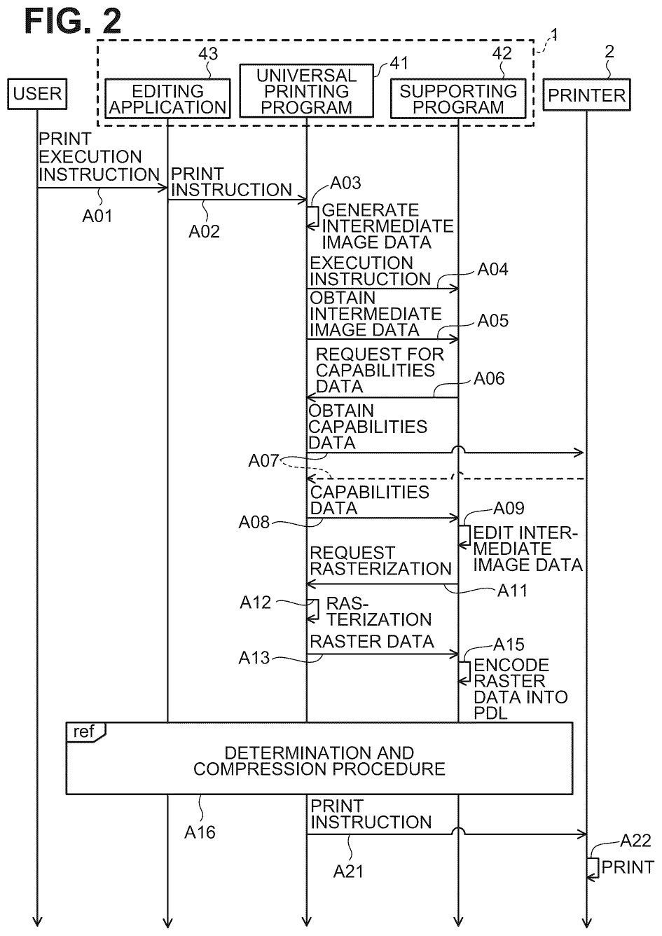

First, a printing procedure will be described with reference to FIG. 2. The editing application 43 allows the user to create or edit documents and images. In a case where the user intends to print a document or image being displayed, the user inputs an instruction to execute printing in the editing application 43 (A01). When the OS 21 includes the universal printing program 41, the editing application 43 determines that it has received an execution instruction instructing the universal printing program 41 to cause the printer 2 to print the currently selected image.

The editing application 43 passes the details of the print execution instruction to the universal printing program 41 (B02). The universal printing program 41 thus obtains image data representing the image to be printed and the print settings, as the details of the print execution instruction, from the editing application 43.

The universal printing program 41 generates intermediate image data by converting the image data to an intermediate image data format based on the print settings received from the editing application 43 (A03). The image data included in the editing application 43 is of various types. The universal printing program 41 thus converts image data representing the image to be printed into intermediate image data suitable for generating print data. When the received image data is in a suitable format, the generation of intermediate image data may be omitted, and the image data may be used as intermediate image data as is, without conversion.

Before generating the intermediate image data, the universal printing program 41 may launch the supporting program 42 corresponding to the printer 2, which is the designated device, and notify the supporting program 42 that the processing of the print job has begun. When the supporting program 42 is launched by the universal printing program 41, the supporting program 42 is allowed to pass information indicating various instructions to be used when the intermediate image data is generated, to the universal printing program 41, as necessary.

After generating the intermediate image, the universal printing program 41 launches the supporting program 42 (A04). The supporting program 42 can obtain the intermediate image data generated by the universal printing program 41 by, for example, making a request to the universal printing program 41 (A05). A05 is an example of obtaining intermediate data. The intermediate image data is an example of intermediate data.

After the supporting program 42 is launched in response to receiving the instruction in step A04, the supporting program 42 obtains capabilities data of the printer 2. More specifically, the supporting program 42 requests the universal printing program 41 to obtain the capabilities data (A06). In response to receiving the request, the universal printing program 41 transmits a command that requests capabilities data to the printer 2, and obtains the capabilities data from the printer 2 (A07). The universal printing program 41 then passes the obtained capabilities data to the supporting program 42 (A08). The supporting program 42 thus obtains the capabilities data of the printer 2.

In A07, the universal printing program 41 performs communication with the printer 2 via the OS 21 in accordance with, for example, the Internet Printing Protocol (abbreviated as IPP). In other embodiments, for example, the supporting program 42 may obtain the capabilities data directly from the printer 2 using, for example, the Management Information Base (abbreviated as MIB), instead of obtaining the capabilities data via the universal printing program 41.

The capabilities data obtainable from the printer 2 includes information on parameters that can be set as print settings, as well as information on compression methods supported by the printer 2. The capabilities data may further include, for example, remaining life of consumables, available trays, sheet sizes assigned to trays, and available print resolutions. In other embodiments, for example, the printer 2 may have a function of performing image processing based on a received print job and printing using image data obtained from the image processing. The printing enabled by this function may be, for example, consolidated printing such as N-in-one printing, embedded printing such as printing with a watermark, or colorant saving printing. In a case where the printer 2 has an image processing function that can be executed by the printer 2 itself, the printer 2 may pass capabilities data including information on the function to the universal printing program 41 or the supporting program 42. The printer 2 may pass capabilities data including a status of the printer 2 to the universal printing program 41 or the supporting program 42.

The universal printing program 41 also launches the supporting program 42, for example, when it receives an instruction for detailed print settings related to printing on the printer 2. The supporting program 42, which is launched based on the instruction for detailed print settings, can obtain capabilities data of the printer 2 by requesting it from the universal printing program 41, just as in A06 to A08. If, when launched in A04, the supporting program 42 has already obtained the capabilities data, it does not need to obtain this data as described in A06 to A08.

The supporting program 42 edits the intermediate image data, if necessary, based on the received print settings and capabilities data of the printer 2 (A09). The supporting program 42 passes the intermediate image to the universal printing program 41 and requests the universal printing program 41 to rasterize the intermediate image (A11).

The universal printing program 41 rasterizes the intermediate image to generate raster data, which is bitmap data (A12). Further, the universal printing program 41 passes the generated raster data to the supporting program 42 (A13). The supporting program 42 thus obtains the raster data.

Instead of the universal printing program 41, the supporting program 42 may perform rasterization. In this case, the supporting program 42 performs rasterization based on the intermediate image data, and generates raster data. The supporting program 42 may provide greater flexibility in rasterization than the universal printing program 41, which is likely to result in raster data that is suitable for printing by the printer 2. However, rasterization by the universal printing program 41 may enable the supporting program 42 to execute less processing, thus reducing the size of the supporting program 42.

The supporting program 42 then encodes the raster data obtained in B13 into PDL data to generate print data (A15). The print data to be generated in A15 may be in any format printable by the printer 2. The PDL data generated by the supporting program 42 may be in a format that can also be used for printing on printers other than the model of the printer 2.

Before passing an instruction to send print data to the printer 2 to the universal printing program 41, the supporting program 42 executes a determination and compression procedure (A16). The determination and compression procedure determines whether to compress the print data and transmit it to the printer 2, and, if compression is to be performed, whether the compression is to be performed by the supporting program 42 or by the universal printing program 41. Furthermore, if compression is performed, this procedure executes the compression.

Upon receiving an instruction to transmit print data, the universal printing program 41 has a function of compressing the print data using a specified compression method and transmitting the compressed print data. The compression method included in the universal printing program 41 is an example of a first compression method. The universal printing program 41, when not having received a notification that compression is unnecessary, compresses the print data prior to transmission and transmits the compressed print data to the designated destination printer. In contrast, when having received the notification that compression is unnecessary, the universal printing program 41 does not compress the print data and transmits the uncompressed print data to the printer.

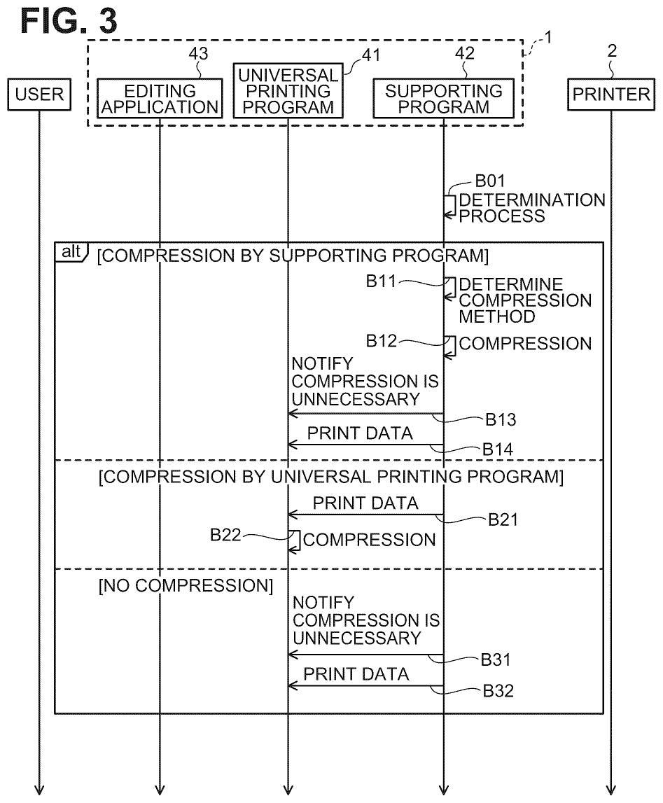

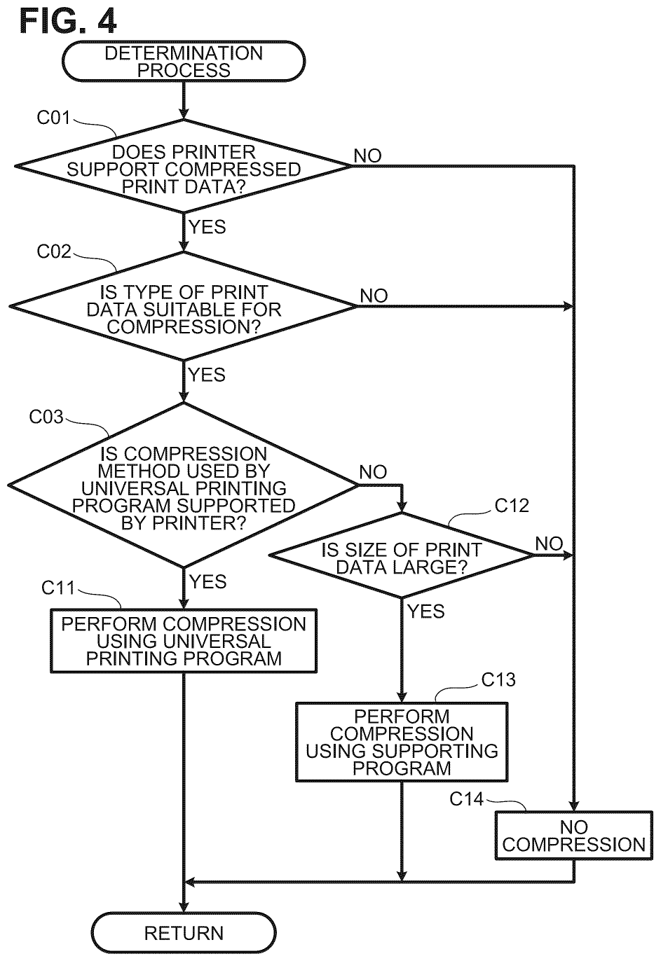

The determination and compression procedure will be described with reference to FIG. 3. In the determination and compression procedure, the supporting program 42 first executes a determination process (B01). The procedure of the determination process will be described with reference to FIG. 4. This determination process is executed by the CPU 11 of the PC 1 based on the supporting program 42.

In the determination process, the CPU 11 determines whether the printer 2 supports the compressed print data (C01). The phrase “the printer 2 supports compressed print data” indicates that the printer 2 has a function of decompressing and printing the received print data if the received print data is compressed data.

The compression methods for image data include various types such as gzip, gif, tiff, and png. The printer 2 that supports compressed print data may support only limited compression methods. The printer 2 may be capable of supporting compressed data in multiple compression methods, or only in a single compression method. The printer 2 that supports compressed data in multiple compression methods, may have different decompression speeds according to the compression method used. Information on the compression methods supported by the printer 2 and the decompression time for each compression method may be included in the capabilities data of the printer 2, or may be pre-stored in the supporting program 42 based on the model information of the printer 2.

The information on the compression methods and the decompression speeds supported by the printer 2 may, for example, be supplied by the vendor of the printer 2. The supporting program 42 may be capable of obtaining various kinds of information from a server or other apparatus based on the model information of the printer 2. For example, the information provided by the server may include decompression speeds that have been actually measured and obtained for each model by the vendor of the printer 2.

When the printer 2 supports print data compressed in at least one compression method, the CPU 11 determines in C01 that the printer 2 supports compressed print data. When the CPU 11 determines, in C01, that the printer 2 supports compressed print data, the CPU 11 further obtains information on all compression methods supported by the printer 2 and the decompression speed for each method.

When the CPU 11 determines that the printer 2 supports compressed print data (C01: YES), the CPU 11 determines whether the type of print data is suitable for compression (C02). The type of print data can be determined from, for example, the file format of the file containing the print data. For example, if the raster data received from the universal printing program 41 in A13 in FIG. 2 is PWG Raster data, the CPU 11 determines that the raster data is suitable for compression, as compressing such data is expected to sufficiently reduce communication load.

When the CPU 11 determines that the type of print data is suitable for compression (C02: YES), the CPU 11 determines whether the compression method used by the universal printing program 41 is supported by the printer 2 (C03). The universal printing program 41 compresses the print data using a specified compression method as described above. The CPU 11 determines, based on the information obtained in C01, whether the compression methods supported by the printer 2 include the compression method used by the universal printing program 41.

When the CPU 11 determines that the compression method used by the universal printing program 41 is supported by the printer 2 (C03: YES), the CPU 11 determines to perform compression using the universal printing program 41 (C11). In this case, as will be described later, the supporting program 42 simply passes the print data to the universal printing program 41, which then compresses the print data using a specified compression method. The condition determined as YES in C03 is an example of a first condition. C03 is an example of determining whether a first condition corresponding to the printer is satisfied.

If the universal printing program 41 can perform multiple compression methods, the CPU 11 determines, in C03, whether any of the compression methods are supported by the printer 2. When the CPU 11 determines that the compression methods used by the universal printing program 41 include a compression method supported by the printer 2, the supporting program 42 stores information specifying the compression method. The supporting program 42 may add information specifying the compression method and pass the print data to the universal printing program 41 in a procedure described later.

When the CPU 11 determines that the compression method used by the universal printing program 41 is not supported by the printer 2 (C03: NO), the CPU 11 determines whether the size of the print data is large (C12).

If the printer 2 does not support the compression method used by the universal printing program 41, transmitting the print data compressed by the universal printing program 41 to the printer 2 may result in improper printing. In this case, the supporting program 42 determines not to perform compression using the universal printing program 41. The supporting program 42 may determine, for example, whether to perform compression itself or not to perform compression. This reduces the occurrence of errors in the printer 2. The supporting program 42 corresponds to the printer 2 and has a function of compressing print data using a compression method supported by the printer 2. The supporting program 42 may be capable of performing compression using a compression method different from that used by the universal printing program 41. The compression method by the supporting program 42 is an example of a second compression method.

When the CPU 11 determines that the size of the print data is large (C12: YES), the CPU 11 determines to perform compression using the supporting program 42 (C13). For example, the CPU 11 may use the aforementioned decompression speed information to compare the sum of the time required for decompression and the time required to transmit the compressed print data with the time required to transmit the print data without compression. For example, when transmitting the compressed print data is expected to result in a shorter overall time, the CPU 11 determines YES in C12.

In C12, the CPU 11 may make the determination based on, for example, the compression method and the size of the print data. For example, the threshold data size used to determine whether the data size is large in C12 may vary for each compression method. Furthermore, if the printer 2 has a low print resolution or if the print data is for a monochrome image, the CPU 11 may determine not to compress the data regardless of its size. The CPU 11 may include the time required for compression in its determination in C12.

In contrast, when the CPU 11 determines that the size of the print data is not large (C12: NO), the CPU 11 determines not to perform compression (C14). If the size of the print data is small, the communication load will not increase. In other words, since the time required for transmission is short for print data having a small size, transmitting the data without compression eliminates the need for compression and decompression processing, which is likely to shorten the overall time required until the printout is produced. Further, transmitting the data without compression reduces the processing load for compression. The condition determined as NO in C12 is an example of a second condition. C12 is an example of determining whether a second condition under which compression is unnecessary is satisfied.

When the CPU 11 determines that the printer 2 does not support compressed print data (C01: NO), the CPU 11 determines not to perform compression (C14). If the printer 2 does not support compressed print data, the printer 2 cannot print if it receives compressed print data. Therefore, the CPU 11 determines that compression is unnecessary. The condition determined as NO in C01 is an example of a second condition. C01 is an example of determining whether a second condition under which compression is unnecessary is satisfied.

When the CPU 11 determines that the type of print data is unsuitable for compression (C02: NO), the CPU 11 determines not to perform compression (C14). For example, in A15 in FIG. 2, when PDF data is generated as print data, the CPU 11 determines that the PDF data is unsuitable for compression. The condition determined as NO in C02 is an example of a second condition. C02 is an example of determining whether a second condition under which compression is unnecessary is satisfied. If the printer 2 is capable of printing based on PDF data, the supporting program 42 can generate PDF data as the print data.

After any of C11, C13, or C14, the CPU 11 ends the determination process and returns to the procedure in FIG. 3. The determination result of the determination process is one of the following: compression by the universal printing program 41, compression by the supporting program 42, or no compression.

The description returns to the determination and compression procedure in FIG. 3. When the determination process in B01 determines that compression is to be performed using the supporting program 42 (alt: [Compression by Supporting Program]), the supporting program 42 determines a compression method (B11). The supporting program 42 may have already determined the compression method in C13 of the determination process. The supporting program 42 compresses the print data using the determined compression method (B12).

If only one compression method is supported by the printer 2, the supporting program 42 compresses the image data using the compression method. If multiple compression methods are supported by the printer 2, the supporting program 42 determines a compression method, for example, based on the type of print data and the decompression speed.

The supporting program 42 notifies the universal printing program 41 that compression is unnecessary (B13), and passes the compressed print data to the universal printing program 41 and instructs the universal printing program 41 to transmit the data to the printer 2 (B14). Since notification has been given that compression is unnecessary, the universal printing program 41 does not compress the print data received from the supporting program 42, and directly uses it as the print data to be transmitted. B13 is an example of causing the universal printing program to set a no-compression setting. B14 is an example of a process for causing the printer 2 to perform printing based on print data compressed by the supporting program 42, and is an example of causing the printer to perform printing based on the print data compressed using the second compression method.

If compression by the supporting program 42 is determined, compression by the universal printing program 41 is unnecessary. When the universal printing program 41 compresses print data as a normal operation, the supporting program 42 sets the universal printing program 41 to disable compression, and thus the universal printing program 41 does not perform compression. This avoids redundant compression.

When the determination process in B01 determines that compression is to be performed using the universal printing program 41 (alt: [Compression by Universal Printing Program]), the supporting program 42 passes the print data without compression to the universal printing program 41 and instructs the universal printing program 41 to transmit the data to the printer 2 (B21). Since the universal printing program 41 has not received the notification that compression is unnecessary, the universal printing program 41 compresses the supplied print data using the compression method used by the universal printing program 41 (B22). The universal printing program 41 uses the compressed print data as the print data to be transmitted. B21 is an example of a process for causing the printer 2 to perform printing based on print data compressed by the universal printing program 41, and is an example of causing the printer to perform printing based on the print data compressed using the first compression method.

If compression by the universal printing program 41 is determined, compression by the supporting program 42 is unnecessary. When the universal printing program 41 compresses print data as a normal operation, the supporting program 42 does not set the universal printing program 41 to disable compression and passes uncompressed print data to the universal printing program 41. This allows the universal printing program 41 to compress print data. When the universal printing program 41 has a compression function supporting multiple compression methods, the supporting program 42, as described above, adds information specifying a compression method and passes the print data to the universal printing program 41 in B21.

When the determination process in B01 determines not to perform compression (alt: [No Compression]), the supporting program 42 notifies the universal printing program 41 that compression is unnecessary (B31). The supporting program 42 passes the uncompressed print data to the universal printing program 41 and instructs the universal printing program 41 to transmit the print data to the printer 2 (B32). Since notification has been given that compression is unnecessary, the universal printing program 41 does not compress the print data received from the supporting program 42, and directly uses it as the print data to be transmitted. B31 is an example of determining whether a second condition under which compression is unnecessary is satisfied. B32 is an example of a process for causing the printer 2 to perform printing based on uncompressed print data, and is an example of causing the printer to perform printing based on the intermediate data obtained in the obtaining, which is uncompressed print data, in response to determination that the second condition is satisfied.

If it is determined that compression is not to be performed, compression by the universal printing program 41 is unnecessary. When the universal printing program 41 compresses print data as a normal operation, the supporting program 42 sets the universal printing program 41 to disable compression, and thus the universal printing program 41 does not perform compression. This avoids redundant compression.

The description returns to the printing procedure in FIG. 2. In response to the instruction from the supporting program 42, the universal printing program 41 transmits, to the printer 2, the print data prepared in one of B14, B22, or B32 in the determination and compression procedure in FIG. 3, and instructs the printer 2 to perform printing (A21). The printer 2 performs printing based on the received print data (A22).

If the received print data is compressed data, the printer 2 decompresses the received print data and performs printing based on the decompressed print data. If the received print data is uncompressed, the printer 2 performs printing based on the received print data. This produces a printout based on the print instruction output from the editing application 43.

In this procedure, the supporting program 42 passes the print data to the universal printing program 41, which then transmits it to the printer 2. Instead, the supporting program 42 may transmit, to the printer 2, both the print data and a print command instructing execution of printing. For example, when a setting related to image processing executable by the printer 2 is included as a print setting, the supporting program 42 may generate a print command including information of the processing. In this case, after completing the transmission of the print data, the supporting program 42 may notify the universal printing program 41 of the completion of the print data transmission.

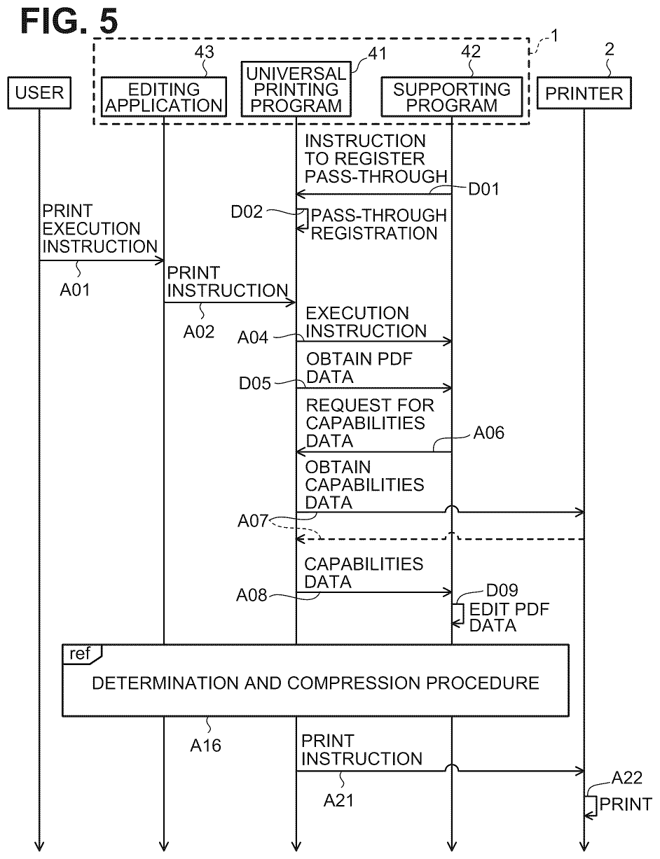

The following describes a printing procedure, with reference to FIG. 5, in which the universal printing program 41 has a pass-through function. The pass-through function enables the universal printing program 41 to use the image data received from the editing application 43 directly as print data, without generating intermediate image data. The universal printing program 41 having the pass-through function can accept pass-through registration for specified file formats. When the universal printing program 41 receives, as image data to be printed, a file in a file format for which pass-through registration has been accepted, the universal printing program 41 does not generate intermediate image data. In the following description and in FIG. 5, steps that are the same as those in FIG. 2 are denoted by the same reference numerals to simplify the description.

When the universal printing program 41 has a pass-through function, the supporting program 42 can issue an instruction for pass-through registration based on the capabilities data of the printer 2. For example, when the printer 2 supports PDF data, the supporting program 42 instructs the universal printing program 41 to perform pass-through registration for the PDF format (D01). D01 is an example of registering a predetermined file format, as a file format not generating intermediate data, to the universal printing program. The phrase “the printer 2 supports PDF data” indicates that the printer 2 has a function of performing printing based on PDF data when the printer 2 receives the PDF data as print data.

When the universal printing program 41 receives information from the supporting program 42 instructing pass-through registration for the PDF format, the universal printing program 41 registers PDF pass-through in association with the identification information of the supporting program 42 (D02).

The universal printing program 41 receives a print instruction from the editing application 43 to instruct the printer 2 to print (A01), and obtains the image data to be printed. When PDF pass-through is registered in association with the supporting program 42 corresponding to the printer 2, and the universal printing program 41 receives a print instruction including PDF data as image data to be printed, the universal printing program 41 does not generate intermediate image data. The following describes a case where the PDF pass-through has been registered and the image data is PDF data.

The supporting program 42 is launched by the universal printing program 41 (A04), and obtains PDF data instead of intermediate image data (D05). D05 is an example of obtaining intermediate data. More specifically, the supporting program 42 requests the universal printing program 41 to obtain the capabilities data of the printer 2 (A06), and obtains the data (A07, A08). The supporting program 42 may edit PDF data as necessary (D09).

When the printer 2 supports PDF data and the supporting program 41 obtains PDF data from the universal printing program 41, the supporting program 41 can use the PDF data as the print data. In this case, since the print data is PDF data, the CPU 11 determines, in the determination process (in B01 in FIG. 3 and in FIG. 4) of the determination and compression procedure, that the type of the print data is unsuitable for compression (NO in C02) and determines not to compress the print data. The supporting program 42 notifies the universal printing program 41 that compression is unnecessary (B31), and passes the PDF data to the universal printing program 41 (B32). The printer 2 supporting PDF data and obtaining PDF data in D05 is an example of the second condition.

When the PDF pass-through has been registered, the universal printing program 41 transmits the PDF data as print data to the printer 2 (A21). The printer 2 performs printing based on the PDF data (A22).

The universal printing program 41 may be capable of accepting pass-through registration not only for PDF data but also for specified file formats. The supporting program 42 may determine not to compress image data to be printed when it has instructed the universal printing program 41 to register pass-through for a specified file format and has obtained the image data in the specified file format from the universal printing program 41 as the image data to be printed. When a specified file format is registered for pass-through, image data in that file format is passed to the printer 2. Thus, by not compressing the data, appropriate print data is transmitted to the printer 2.

In the procedure in FIG. 5, the universal printing program 41 launches the supporting program 42 (A04), but may be configured not to launch the supporting program 42 when pass-through registration has been stored. The universal printing program 41 may be configured such that, when pass-through registration has been stored and the universal printing program 41 has received image data in a specific file format registered as a pass-through format from the editing application 43, the universal printing program 41 transmits image data directly to the printer 2 without launching the supporting program 42. When the universal printing program 41 is configured to compress the received image data before transmission, the supporting program 42 may also notify the universal printing program 41 that compression is unnecessary when registering the PDF format as a pass-through format.

In the above description, the universal printing program 41 compresses the print data before transmission when it has not received a notification that compression is unnecessary. However, the universal printing program 41 may also be configured not to perform compression if it has not received such a notification. In other words, the universal printing program 41 may be configured to compress the print data before transmission upon receiving a notification to perform compression. In this configuration, when compression by the universal printing program 41 is determined, the supporting program 42 notifies the universal printing program 41 to compress the print data when passing the data to the universal printing program 41. More specifically, in this configuration, the determination and compression procedure is modified from that illustrated in FIG. 3 by removing steps B13 and B31, and by adding a step before B21 in which the supporting program 42 passes a compression notification to the universal printing program 41.

As described above in detail, the supporting program 42 in this embodiment determines whether a first condition indicating that the universal printing program 41 performs compression is satisfied, for example, according to the capabilities data of the printer 2. When the first condition is satisfied, the supporting program 42 causes the universal printing program 41 to compress the print data using a first compression method, and then passes the compressed print data to the printer 2 for printing. In contrast, when the first condition is not satisfied, the supporting program 42 does not cause the universal printing program 41 to compress the print data using the first compression method. This utilizes the compression function of the universal printing program 41 and reduces communication load by transmitting compressed print data.

While the disclosure has been described in detail with reference to the specific embodiment thereof, this is merely an example, and various changes, arrangements and modifications may be applied therein without departing from the spirit and scope of the disclosure. Any apparatuses or devices having a printing function may be connected to the PC 1. Examples of such apparatuses or devices include multifunction peripherals, copying machines, and facsimile machines. The number of printers to be connected to the PC 1 is not limited to the illustrated example; two or more printers may be connected.

In the printing procedure illustrated in FIG. 2, the supporting program 42 determines whether to perform compression after generating print data; however, the timing of this determination is not limited to this example. The supporting program 42 may make the determination when obtaining the capabilities data of the printer 2 (A08 in FIG. 2). For example, in a situation where the supporting program 42 has previously obtained the capabilities data of the printer 2, the supporting program 42 may make the determination based on the intermediate image data when obtaining the intermediate image data from the universal printing program 41 (A05 in FIG. 2). The supporting program 42 may also make the determination based on the raster data when obtaining the raster data from the universal printing program 41 (A13 in FIG. 2), for example. The supporting program 42 may be capable of accepting a user selection as to whether to perform compression.

For example, the supporting program 42 may perform various processes depending on whether the print data is to be compressed. The supporting program 42 may, depending on whether compression is performed, modify the editing contents during the editing of intermediate image data (A09 in FIG. 2), edit the raster data obtained in A13 in FIG. 2, or select whether rasterization is performed by the universal printing program 41 or by the supporting program 42, among other processes.

In the present embodiment, the description has been provided only for the printing operation in which the supporting program 42 is involved. However, the supporting program 42 may be involved in operations other than the printing operation. The program that executes the processing of the present embodiment is not limited to the supporting program 42, but may be any program that can accept instructions from the OS 21 or the universal printing program 41 when performing printing using the universal printing program 41. For example, a print workflow application (Print Workflow) for which the specifications have been disclosed by Microsoft Corporation may be used.

The execution timing of the supporting program 42 is not limited to the examples of the present embodiment. For example, the supporting program 42 may be executed upon receiving a direct execution instruction from the OS 21. Alternatively, the supporting program 42 may be a resident program. When the supporting program 42 is resident, the supporting program 42 may perform the above-described operations in response to an execution instruction.

In any sequence diagram disclosed in the present embodiment, steps may be executed in a different order or in parallel, provided no inconsistency arises in the contents of the procedures.

The processing in all steps disclosed in the present embodiment may be executed by hardware, such as a single CPU, multiple CPUs, an ASIC, or a combination thereof. The processing in all steps disclosed in the present embodiment may be implemented in various forms, such as a recording medium storing a computer-readable program for executing the processing, or as a method.

While the disclosure has been described in detail with reference to the specific embodiment thereof, this is merely an example, and various changes, arrangements and modifications may be applied therein without departing from the spirit and scope of the disclosure.

What is claimed is:

1. A non-transitory computer-readable storage medium storing a supporting program executable by a computer of an information processing apparatus and corresponding to a printer connectable to the information processing apparatus, the supporting program causing the computer to perform operations comprising:
in a case where a print instruction output from an application program incorporated in the information processing apparatus instructs a universal printing program included in an operating system incorporated in the information processing apparatus to cause the printer to perform printing an image,
obtaining intermediate data representing the image to be printed from the universal printing program;
determining whether a first condition corresponding to the printer is satisfied;
in response to determining that the first condition is satisfied, causing the universal printing program to compress print data based on the intermediate data obtained in the obtaining using a first compression method supported by the universal printing program, and causing the printer to perform printing based on the print data compressed using the first compression method.

2. The non-transitory computer-readable storage medium according to claim 1, wherein the supporting program causes the computer to perform operations further comprising:
in response to determining that the first condition is not satisfied in the determining, causing the universal printing program not to compress print data, based on the intermediate data obtained in the obtaining, using the first compression method.

3. The non-transitory computer-readable storage medium according to claim 2, wherein the supporting program causes the computer to perform operations further comprising:
in response to determining that the first condition is not satisfied in the determining, setting the universal printing program to disable compression, wherein the universal printing program compresses the print data using the first compression method when the universal printing program is not set to disable compression, and does not compress the print data when the universal printing program is set to disable compression.

4. The non-transitory computer-readable storage medium according to claim 1, wherein the supporting program causes the computer to perform operations further comprising:
in response to determining that the first condition is not satisfied in the determining, compressing the print data based on the intermediate data obtained in the obtaining using a second compression method supported by the printer, and causing the printer to perform printing based on the print data compressed using the second compression method.

5. The non-transitory computer-readable storage medium according to claim 4, wherein the supporting program causes the computer to perform operations further comprising:
in response to the print instruction, determining whether a second condition under which compression is unnecessary is satisfied;
in response to determining that the second condition is not satisfied and the first condition is not satisfied, causing the printer to perform printing based on the print data compressed using the second compression method;
in response to determining that the second condition is not satisfied and the first condition is satisfied, causing the printer to perform printing based on the print data compressed using the first compression method; and
in response to determining that the second condition is satisfied, causing the printer to perform printing based on the intermediate data obtained in the obtaining, which is uncompressed print data.

6. The non-transitory computer-readable storage medium according to claim 5, wherein the second condition is that the size of the print data based on the intermediate data obtained in the obtaining is smaller than a threshold.

7. The non-transitory computer-readable storage medium according to claim 5, wherein the second condition is that the printer does not support compression.

8. The non-transitory computer-readable storage medium according to claim 5, wherein the supporting program causes the computer to perform operations further comprising:
registering a predetermined file format, as a file format not generating intermediate data, to the universal printing program;
in a case where image data input as the image to be printed is in the predetermined file format registered in the registering, causing the printer to perform printing based on the image data in the file format registered without generating intermediate data; and
in a case where the predetermined file format is registered in the universal printing program as a file format not generating intermediate data, obtain the image data in the predetermined file format registered from the universal printing program, instead of the intermediate data, and
wherein the second condition is that, in the obtaining, the image data in the predetermined file format is obtained.

9. The non-transitory computer-readable storage medium according to claim 5, wherein the second condition is that the printer supports print data in a predetermined file format, that the print data based on the intermediate data obtained in the obtaining is in the predetermined file format, and that the predetermined file format is unsuitable for compression.

10. The non-transitory computer-readable storage medium according to claim 9, wherein the predetermined file format is a PDF format.

11. The non-transitory computer-readable storage medium according to claim 5, wherein the supporting program causes the computer to perform operations further comprising:
in response to determining that the second condition is satisfied, setting the universal printing program to disable compression,
wherein the universal printing program compresses the print data using the first compression method when the universal printing program is not set to disable compression, and does not compress the print data when the universal printing program is set to disable compression.

12. The non-transitory computer-readable storage medium according to claim 1, wherein the first condition is that the printer supports the first compression method.
